(19) United States
(12) Patent Application Publication
(10) Pub. No.: US 2026/0089700 A1
(43) Pub. Date: Mar. 26, 2026

(54) COLLISION RESOLUTION FOR AMBIENT INTERNET OF THINGS (A-IOT) COMMUNICATIONS

(71) Applicant: QUALCOMM Incorporated, San Diego, CA (US)

(72) Inventors: Raviteja Patchava, San Diego, CA (US); Piyush Gupta, Bridgewater, NJ (US); Peter Gaal, San Diego, CA (US); Xiaoxia Zhang, San Diego, CA (US); Kazuki Takeda, Minato-ku (JP); Yuchul Kim, San Diego, CA (US); Le Liu, San Jose, CA (US); Junyi Li, Greentown, PA (US)

(21) Appl. No.: 18/898,139

(22) Filed: Sep. 26, 2024

(51) Int. Cl. H04W 72/0453; H04W 74/0808

(52) U.S. Cl. CPC H04W 72/0453; H04W 74/0808

(57) ABSTRACT

Techniques for collision resolution in Ambient Internet of Things (A-IoT) communications are described. A reader device obtains sampling frequency offset (SFO) indications for received random access messages and generates collision indicators based on the SFOs. The reader device may then allocate resources for subsequent transmissions using various strategies, such as omitting allocations for colliding devices, providing multiple allocations, or matching allocations to specific SFO values. A-IoT devices receive these allocations along with collision indicators and adjust their subsequent transmissions accordingly, either by selecting from multiple resources or generating new access sequences. This approach enables efficient collision handling while accommodating the limitations of low-complexity A-IoT devices.

### BACKGROUND

### Field of the Disclosure

This disclosure relates generally to wireless communication, and more specifically, to collision detection and resolution in random access procedures for Ambient Internet of Things (A-IoT) devices using sampling frequency offset (SFO) information and adaptive resource allocation strategies.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Wireless communication systems are increasingly incorporating Internet of Things (IoT) devices, which often have limited power and computational resources. In dense deployments, these devices can experience collisions when attempting to access the network simultaneously. Traditional collision resolution techniques, such as random backoff, can be inefficient for IoT applications due to increased latency and power consumption.

Ambient IoT (A-IoT) devices, which often use backscatter communication, present additional challenges. These devices typically lack sophisticated timing circuits, leading to significant sampling frequency offsets (SFOs) between the device and a reader device. Moreover, their use of simple modulation schemes and limited sequence spaces increases the likelihood of collisions.

Existing collision detection methods lack in an ability to identify collisions when multiple devices use the same access sequence. This limitation becomes more pronounced in A-IoT scenarios, where the sequence space is constrained by the devices'simplicity. Further, current resource allocation strategies for collision resolution may not adequately account for the unique characteristics of A-IoT devices, such as their limited ability to perform complex randomization or timing adjustments.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless base station. The wireless base station includes a processing system with one or more processors and one or more memories coupled with the one or more processors. The processing system is configured to cause the wireless base station to: obtain an indication of one or more sampling frequency offsets (SFOs) associated with one or more first messages; generate a collision indicator associated with the one or more first messages based on the obtained SFO indication; and output, for transmission, at least one second message including resource allocation information for at least a third message, wherein the resource allocation information is associated with the collision indicator.

In some examples, the collision indicator is generated if two or more of the first messages use a same code division multiplexing (CDM) sequence or have different ones of the indicated SFOs. In some implementations, the wireless base station associates different portions of the resource allocation information with subsets of the first messages based on their SFO values. The second message may include the collision indicator associated with one or more CDM sequences. In certain examples, the wireless station outputs multiple second messages, each including a portion of the resource allocation information. The resource allocation information may include multiple allocations, each associated with a different indicated SFO. In some cases, obtaining the SFO indication involves filtering an upsampled signal using frequency shifted matched filters.

Another innovative aspect of the subject matter described in this disclosure can be implemented in a method for wireless communication by a wireless communication device. The method includes: outputting, for transmission, one or more first messages; obtaining at least one second message including resource allocation information and a collision indicator associated with the one or more first messages; and outputting, for transmission, a third message by using at least one resource indicated by the resource allocation information, wherein the at least one resource is associated with the collision indicator.

In some examples, the wireless communication device generates the first messages using a sequence associated with a hash function. The sequence may be a code division multiplexing (CDM) sequence or a pseudo-noise (PN) sequence. In certain implementations, the device generates subsequent messages using different sequences based on the collision indicator. Some examples involve estimating an SFO, matching it with an SFO indicator in the second message, and using a corresponding resource allocation for transmitting the third message. In some cases, the device aggregates partial resource allocation information from multiple second messages and selects a resource using random selection or a hash function. The first messages may be output for transmission via a backscattered signal.

Details of one or more implementations of the subject matter described in this disclosure are set forth in the accompanying drawings and the description below. Other features, aspects, and advantages will become apparent from the description, the drawings and the claims. Note that the relative dimensions of the following FIGs. may not be drawn to scale. While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF DRAWINGS

The appended FIGs. depict certain features of the various aspects described herein and are not to be considered limiting of the scope of this disclosure.

FIG. 1 depicts an example of a wireless communications network 100, in which aspects described herein may be implemented according to aspects described herein.

FIG. 2 depicts an example disaggregated base station 200 architecture according to aspects described herein.

FIG. 3 depicts aspects of an example BS 102 and a UE 104 according to aspects described herein.

FIGS. 4A, 4B, 4C, and 4D depict aspects of data structures for a wireless communications network, such as wireless communications network 100 of FIG. 1 according to aspects described herein.

FIG. 5A depicts a diagram 500 illustrating a first deployment scenario for an ambient Internet of Things (IoT) device according to aspects described herein.

FIG. 5B depicts a diagram 510 illustrating a second deployment scenario for an ambient Internet of Things (IoT) device according to aspects described herein.

FIG. 6 is a diagram illustrating an example system 600 associated with an ambient Internet of Things (IoT) device according to certain aspects.

FIG. 7 shows a flowchart illustrating an example process 700 performable by or at a network entity that supports collision resolution in Ambient Internet of Things (A-IoT) communications according to aspects described herein.

FIG. 8 depicts aspects of an example communications device 800 according to aspects described herein.

FIG. 9 shows a flowchart illustrating an example process 900 performable by or at an Internet of Things (IoT) device that supports collision resolution in Ambient IoT (A-IoT) communications according to aspects described herein.

FIG. 10 depicts aspects of an example communications device 1000 according to aspects described herein.

### DETAILED DESCRIPTION

The present disclosure relates to techniques for collision resolution in wireless communication systems, particularly for Ambient Internet of Things (A-IoT) devices. In some aspects, a reader device, e.g., a wireless base station, user equipment, other network node, or the like obtains sampling frequency offset (SFO) indications associated with received random access messages from multiple A-IoT devices. The reader device generates collision indicators for the messages based on the SFO indications, allowing it to detect collisions even when devices use the same access sequence. Upon detecting a collision, the reader device may respond in different ways. It may choose not to allocate resources for colliding devices and instead force them to retry access later. Alternatively, the reader device may allocate multiple resources for colliding devices, allowing them to randomly select a resource for subsequent transmissions. In another approach, the reader device may allocate resources specifically matched to detected SFO values, enabling devices to select resources based on their estimated SFO. These techniques can be implemented through a series of message exchanges, where devices initially transmit random access requests, the reader device responds with resource allocations and collision information, and devices then transmit further messages using the allocated resources.

On the device side, A-IoT sensors receive resource allocation information and collision indicators from the reader device. They use the information to determine how to proceed with subsequent transmissions. Devices may generate new access sequences if a collision is indicated, or they may select from multiple allocated resources based on either random selection or their estimated SFO. This approach allows for efficient collision resolution while accounting for the unique characteristics of low-cost, low-complexity A-IoT devices.

In addition to the foregoing collision resolution techniques, certain aspects incorporate signal processing methods at the reader device. For instance, multiple SFO hypothesis testing can be used to efficiently detect transmissions from multiple users, even when their signals overlap in time and frequency. This approach involves applying frequency-shifted matched filters to received upsampled signals, correlating the results with possible access sequences, and comparing the outcomes against noise thresholds. The reader device can then detect multiple sequences and their corresponding SFOs, enabling it to distinguish between colliding devices using the same sequence but with different timing offsets.

The A-IoT devices in some implementations are designed to operate with minimal complexity while still participating in advanced collision resolution schemes. They may use simple binary orthogonal sequences or pseudo-noise (PN) sequences for their initial transmissions while relying on backscatter modulation to conserve energy. When responding to collision indications, devices can employ hash functions to select new sequences or resources to balance randomness with deterministic behavior to minimize repeated collisions.

One or more of the following advantages can be realized by the aspects described herein. By utilizing SFO information to detect collisions, certain implementations enable more accurate collision detection compared to traditional methods. This can lead to improved system capacity and reduced latency in random access procedures. Also, the ability to detect collisions even when devices use the same access sequence allows for more efficient use of the limited sequence space available in A-IoT systems.

The flexible response options provided to the reader device upon collision detection allow for optimized handling of different network conditions. When the network is congested, the option to not allocate resources for colliding devices can help prevent further congestion. In less congested scenarios, allocating multiple resources allows for quick resolution of collisions without requiring devices to fully restart the access procedure.

For A-IoT devices, the ability to select resources based on their estimated SFO can improve transmission success rates. This ability takes advantage of the natural variation in device characteristics to spread transmissions across different resources to reduce the likelihood of repeated collisions. Additionally, the option for devices to use different sequences on retry attempts when collisions are explicitly indicated can help break deadlock situations where multiple devices repeatedly collide.

In view of the foregoing, described implementations balance the needs of the network and the limitations of A-IoT devices. By allowing for collision resolution through targeted resource allocation rather than solely relying on device retries, described implementations can maintain efficiency even with a large number of low-complexity devices. This can result in improved battery life for A-IoT devices and more predictable performance in large-scale deployments.

The use of multiple SFO hypothesis testing at the reader device can also provide benefits. SFO hypothesis testing allows for detection of a larger number of simultaneous transmissions compared to traditional methods, improving scalability of the system for dense IoT deployments. This also enhances the ability to distinguish between devices with similar signal strengths, which is challenging in backscatter-based systems where power control is limited.

For A-IoT devices, the ability to use simple binary sequences and backscatter modulation reduces their power consumption and hardware complexity. This makes the system more accessible for ultra-low-power applications and extends the operational lifetime of battery-powered devices. Also, using hash functions for sequence and resource selection provides a balance between randomness and determinism, which helps to distribute retries effectively without requiring complex random number generators in the devices.

As seen, the foregoing features consider the asymmetric capabilities of reader devices and A-IoT devices. By placing the computational burden of collision detection and resolution primarily on the reader device, described implementations generally allow for sophisticated network management without compromising the simplicity and energy efficiency of A-IoT devices. This asymmetry enables deployment of large numbers of simple sensors or tags while maintaining efficient use of wireless resources.

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

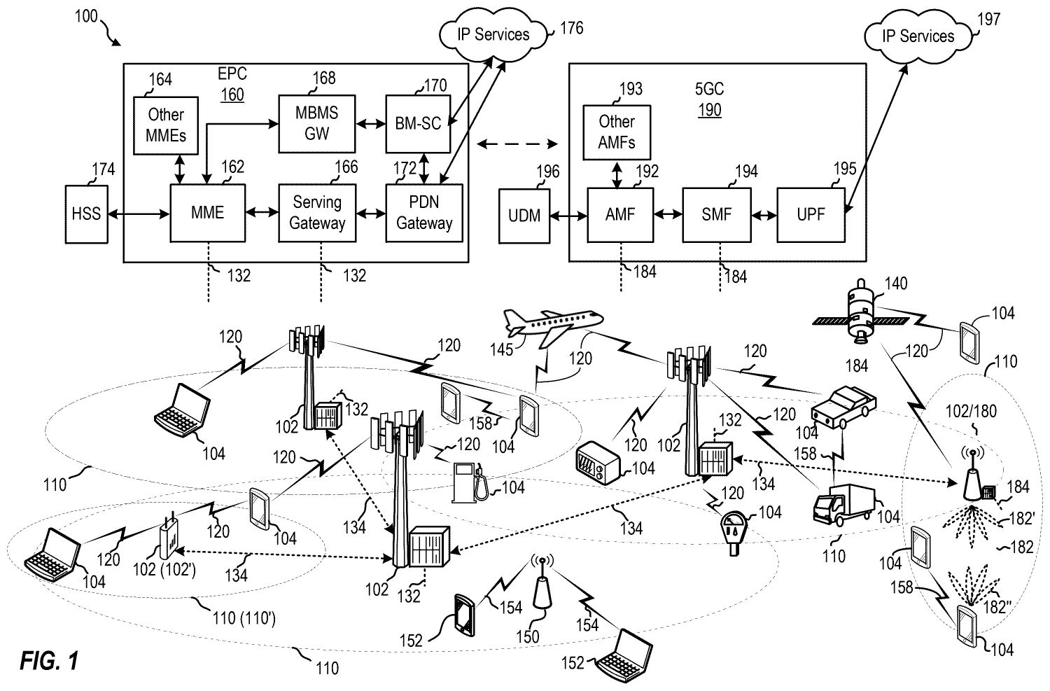

FIG. 1 depicts an example of a wireless communications network 100, in which aspects described herein may be implemented. Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

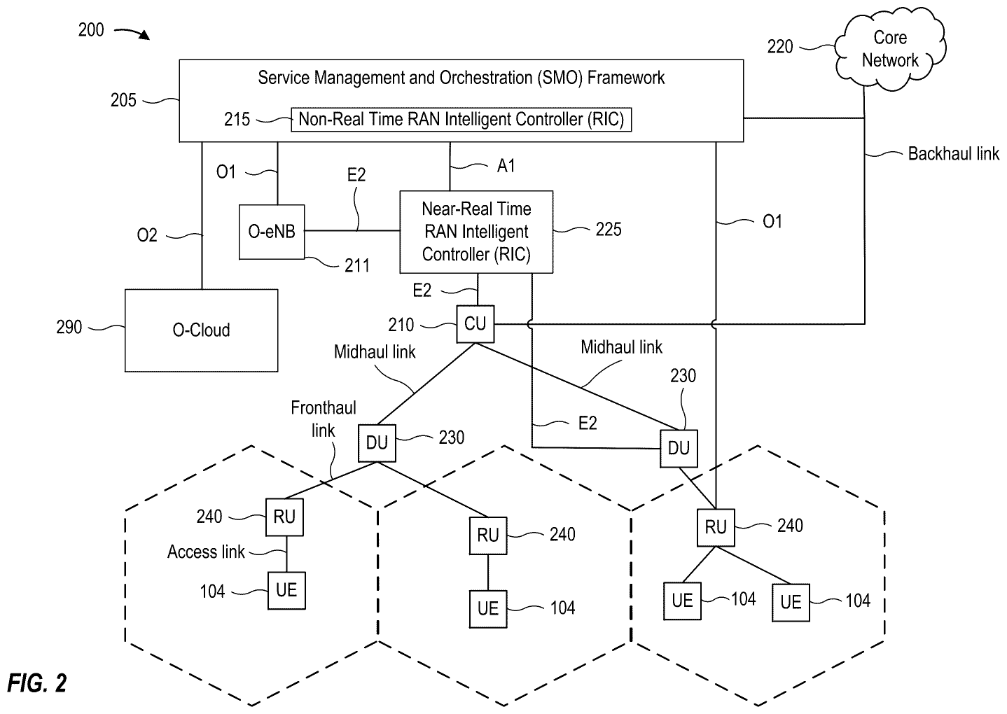

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

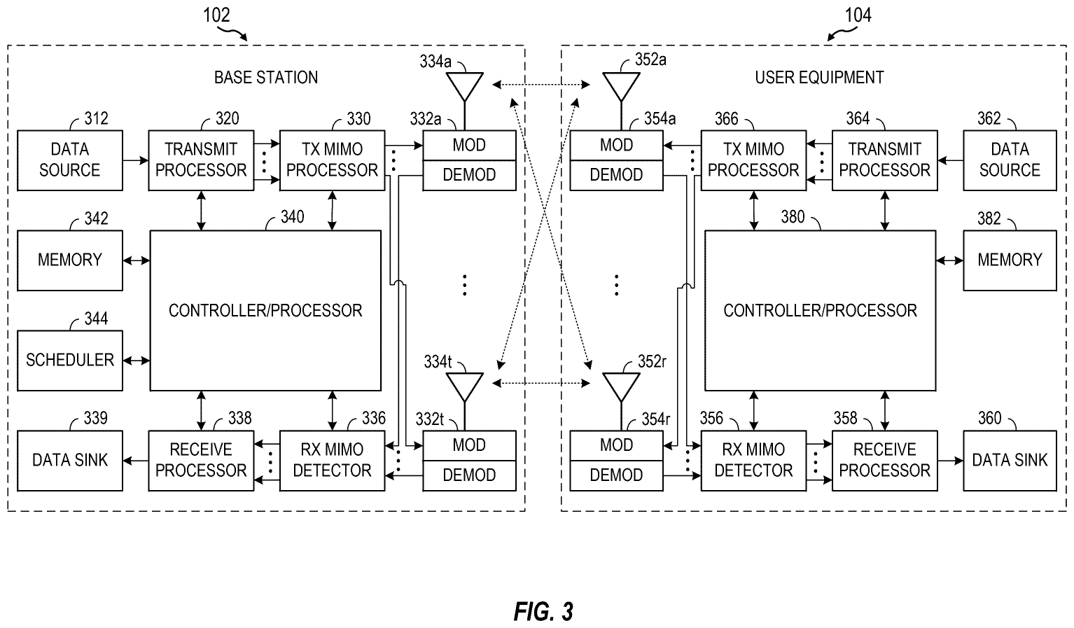

FIG. 3 depicts aspects of an example BS 102 and a UE 104. Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively. Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

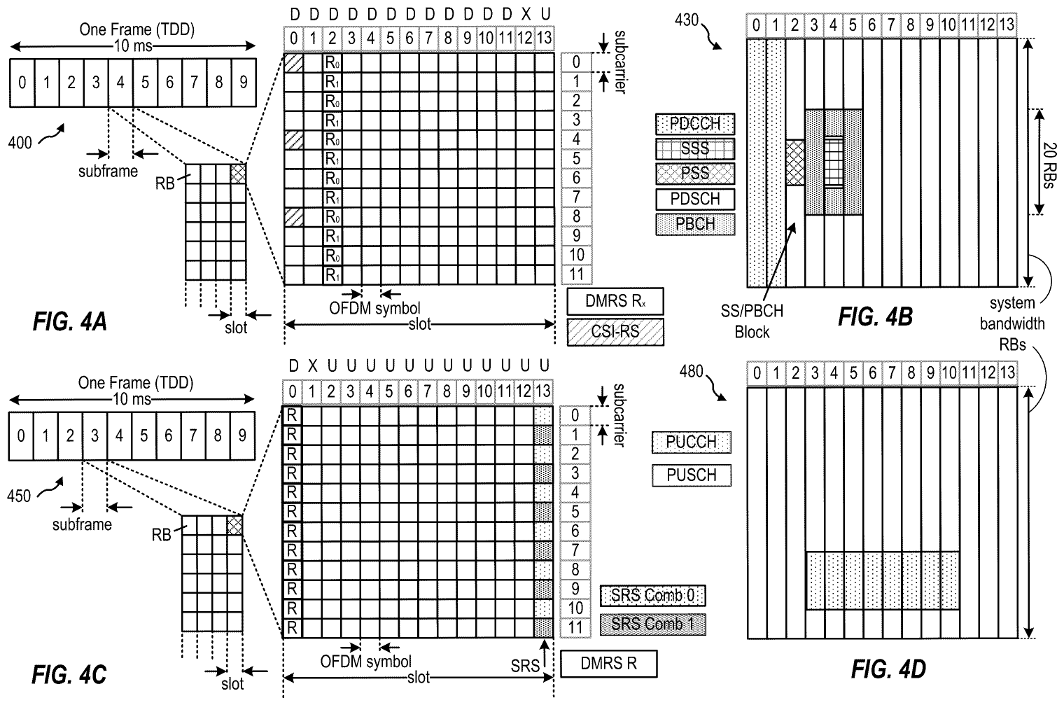

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μslots/subframe. The subcarrier spacing and symbol length/duration are a function of the numerology. The subcarrier spacing may be equal to 2\hat{ }μ×15 kHz, where μis the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

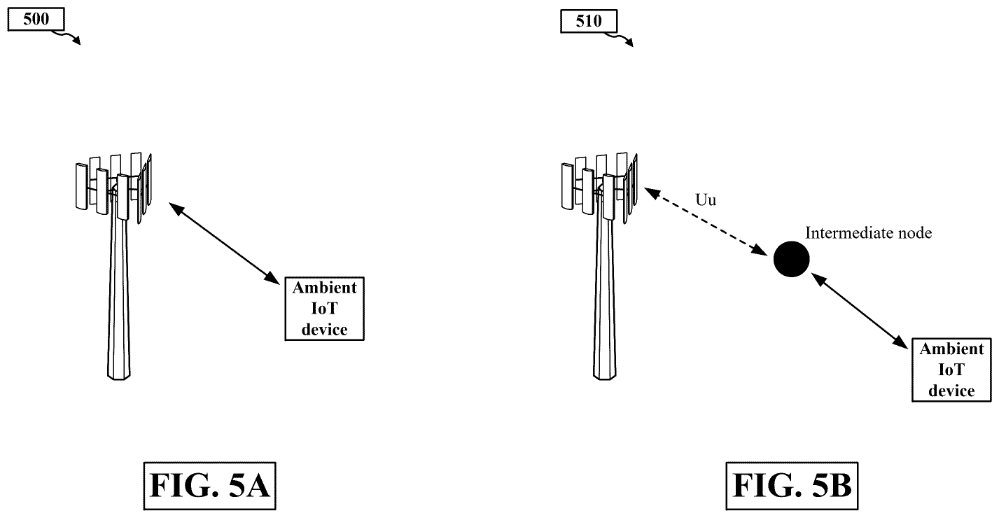

In wireless communications, ambient IoT devices may be deployed in different scenarios. For example, a first deployment scenario may include a first topology where the ambient IoT device coexists with a network entity (e.g., base station), where the ambient IoT device may operate in a manner similar to a micro-cell or co-site, as shown for example in diagram 500 of FIG. 5A. In another example, a second deployment scenario may include a second topology where a first wireless device (e.g., UE) may operate as an intermediate node between the network entity and the ambient IoT device, and may be under network control, as shown for example in diagram 510 of FIG. 5B. The ambient IoT device may coexist with the network entity, where the ambient IoT device may operate in a manner similar to a micro-cell or co-site, while the location of the intermediate node (e.g., first wireless device, UE) may be indoors or inside a building or structure.

The traffic types may include device originated (DO) device terminate triggered (DTT), device terminate (DT) with a focus on indoor inventory (rUC1) and indoor command (rUC5). Some use cases for inventory may include indoor or outdoor environments. For indoor environments, some use cases may include automated warehousing, medical instrument inventory management and positioning, non-public network for logistics, manufacturing, airport terminal, shipping port, smart consumer electronics, automated supply chain distribution, fresh food supply chain, end-to-end logistics, auctions, or electronic shelf labels. For outdoor environments, some use cases may include medical instrument inventory management and positioning, non-public network for logistics, airport terminal, shipping port, or automated supply chain distribution. Some use cases for command may also include indoor or outdoor environments. For indoor environments, some use cases may include online modification of medical instrument status, device activation and deactivation, health care, device permanent deactivation, or electronic shelf label. For outdoor environments, some use cases may include online modification of medical instruments status, device activation and deactivation, health care, or controller in smart agriculture.

For instances of the second topology, the manner in which the intermediate node (e.g., first wireless device, UE) is scheduled to assist with the communication with the ambient IoT device is discussed herein.

Aspects presented herein provide a configuration for scheduling a first wireless device to assist in communication with an ambient IoT device. For example, a network may schedule the UE to assist with the communication with the ambient IoT device. The network may determine the resources for the backhaul link and the forward link for interference management across the first wireless device and the ambient IoT device.

In some aspects, the network may allocate resources in order to instruct the first wireless device to assist with the communication with the ambient IoT device. For example, the resource allocation may be fully controlled by the network such that resources are allocated per transmission. The network may indicate whether the resources are for backhaul links or forward links. The network may also indicate whether the resources are for a target ambient IoT device, groupcast, or broadcast and the corresponding resource allocation. The network may provide a control signal to the first wireless device that indicates whether the control signal is for inventory or command operation. In some aspects, the control signal may indicate the purpose of the command, such as but not limited to, activation, deactivation, terminate operability of the device, or the like. For example, a different DCI format, a different radio network temporary identifier (RNTI), or a bit field in the control signal may be utilized to indicate that the control signal is for inventory or command operation (e.g., purpose of the command). In some aspects, a control signal may be utilized for one transmission. In some aspects, a control signal may be utilized for a plurality of transmissions.

In some aspects, the resource allocation may be partially controlled by the network. In such instances, the network may indicate a single resource to the first wireless device. For example, in some aspects, the utilization of the resource may be determined by the first wireless device. A size of the allocated resources may be based on whether the resources are to be utilized for inventory or command operation. In instances of inventory operation, the size of the allocated resources may be based on an allowed number of inventory rounds (e.g., contention based access procedure). One inventory round refers to a first wireless device (e.g., UE) transmit query to identify whether there are ambient IoT devices are in proximity to the first wireless device, ambient IoT device response information, and contention resolution. In instances of command operation, the size of the allocated resources may be based on whether the ambient IoT device triggered the command operation or if the downlink transmission triggered the command operation. When the ambient IoT device triggers the command operation, the size of the allocated resources may be based on a buffer status report (BSR) or a scheduling request (SR) indicated by the ambient IoT device. When the downlink transmission triggers the command operation, the size of the allocated resources may be based on the network having knowledge of the requisite resource size.

In some aspects, the network may indicate the resource for backhaul link and forward link separately. The target ambient IoT device, groupcast, or broadcast may not be indicated. The time domain resource allocation may utilize a time gap to indicate the time gap between the received control signal and the resource the first wireless device used to transmit the information to the ambient IoT device. The time domain resource may be used between the first wireless device and the ambient IoT device. In some aspects, the transmission pattern may be configured. The transmission duration of the first wireless device, the gap between the end point of the resource for the UE transmission, and a start point of the resource for the ambient IoT device transmission, and the transmission duration of the ambient IoT device may be configured. In instances of inventory operation, the network may conFIG. an allowed number of rounds of communication from the first wireless device to the ambient IoT device and from the ambient IoT device to the first wireless device.

In some aspects, the time domain resource allocation may utilize an additional bit field to indicate a time pattern of the backhaul link and/or the forward link. In some aspects, the network may dynamically indicate time resources the first wireless device may use to communicate with the ambient IoT device. For example, the network may indicate a duration and the gap between two resource for each transmission. In another example, the network may indicate a common duration for backhaul links, a common duration for forward links, a gap between backhaul links and forward links, and a gap between forward links and backhaul links. In some aspects, a configured table may be utilized to indicate the allocation of multiple resources. For example, a bit field in the control signal may be utilized to indicate a table index.

In some aspects, for a frequency domain resource allocation, the network may indicate a carrier frequency for forward links. With regards to the backhaul links, the ambient IoT device may utilize the entire band. In some aspects, a bit field may be utilized to indicate that frequency shift is supported. In some aspects, the frequency shift may be configured by the network. In some aspects, the frequency range may be indicated by the network.

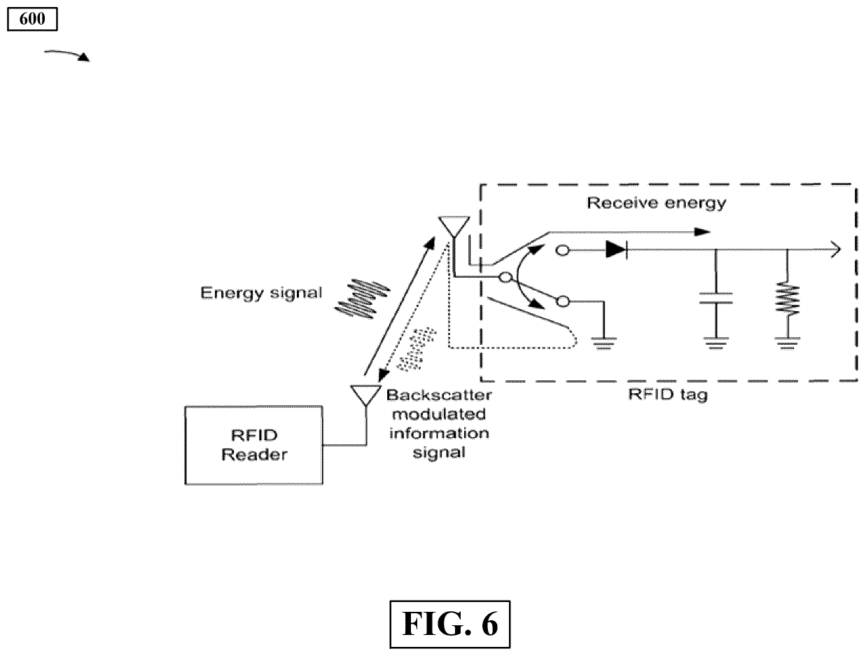

FIG. 6 is a diagram illustrating an example 600 associated with an ambient Internet of Things (IoT) device according to certain aspects. Ambient IoT devices have applications in inventory and asset management (both inside and outside warehouses), sustainable sensor networks in factories and/or agriculture, smart homes, or the like. These devices are designed to communicate with intermediate devices, which relay information to and from network entities.

An ambient IoT device may operate with minimal power requirements, allowing for low operating expense, low maintenance cost, and a long life-cycle. These devices may be passive, semi-passive, or active, depending on their power source and communication capabilities.

A passive ambient IoT device may harvest energy over the air, for example, from signals received from an intermediate device. The harvested energy powers the device's communication circuitry. Semi-passive devices may have a small battery or capacitor to store energy but may still rely on the intermediate device for initiating communication. Active devices may have a more substantial power source, allowing them to initiate communication autonomously.

The ambient IoT device is configured to perform a method of wireless communication and performs, e.g., several functions. It generates first assistant information associated with at least one communication requirement of the ambient IoT device. This information may include details about required resources for communication, the amount of data to be transmitted, or the device type. It also transmits the first assistant information to an intermediate device. This transmission may occur during an inventory occasion, where the device responds to a query from the intermediate device. It also communicates with the intermediate device using one or more resources allocated by a network entity. The resource allocation is associated with the first assistant information previously transmitted.

In some implementations, the ambient IoT device may receive a command from the intermediate device during a command occasion and perform an operation associated with the command. The device may also be configured to communicate using a single resource allocated for communication in a partial control mode, where the network entity exerts limited control over the communication process.

This configuration allows the ambient IoT device to efficiently participate in the IoT ecosystem, providing necessary information for optimal resource allocation while operating under power and communication constraints.

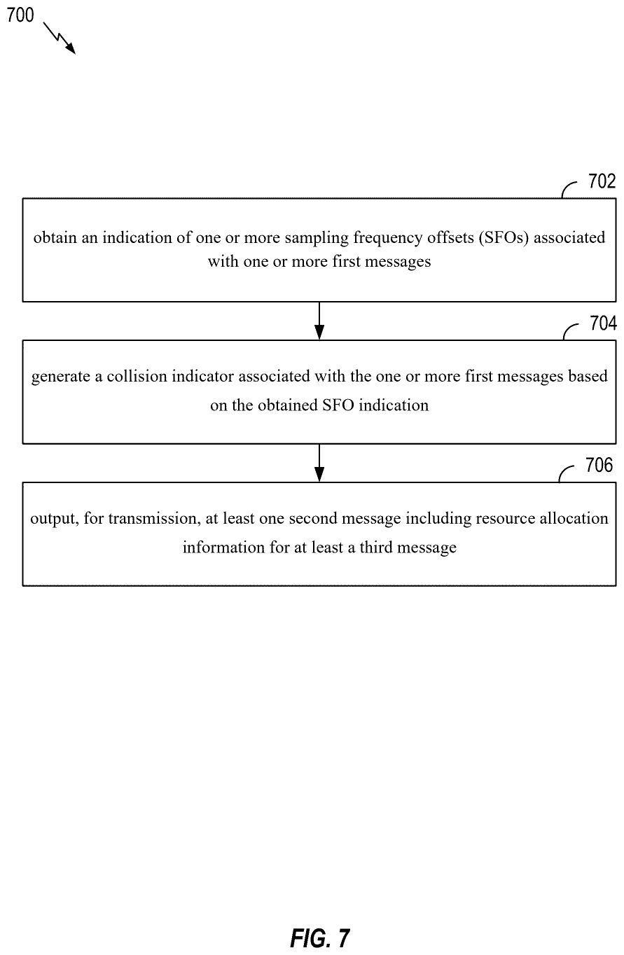

FIG. 7 shows a flowchart illustrating an example process 700 performable by or at a network entity such as a wireless base station, user equipment, or any node that can function as a reader device, and that supports collision resolution in Ambient Internet of Things (A-IoT) communications according to aspects described herein. For example, process 700 may be performed by a network entity, such as BS 102 of FIGS. 1 and 3, or a disaggregated base station as discussed with respect to FIG. 2. In other examples, process 700 may be performed by a user equipment, such as UE 104 described above with respect to FIGS. 1 and 3.

At step 702, the network entity or reader device obtains an indication of one or more sampling frequency offsets (SFOs) associated with one or more first messages. The first messages may be random access requests from A-IoT devices attempting to connect to the network. In some implementations, obtaining the SFO indication involves more complex signal processing. For instance, the network entity or reader device may obtain an upsampled signal and filter it using one or more frequency shifted matched filters, each corresponding to a different SFO value. Doing so enables more accurate detection of SFOs across a range of possible offset values.

At step 704, the network entity or reader device generates a collision indicator associated with the one or more first messages based on the obtained SFO indication. According to some implementations, this involves analyzing the SFO information to identify potential collisions between messages from different devices. The collision indicator may be generated under various circumstances. In one scenario, it is generated if two or more of the first messages use the same code division multiplexing (CDM) sequence. Alternatively, the indicator may be triggered if two or more of the first messages have different indicated SFOs. In some implementations, both conditions are required—the collision indicator is generated when two or more of the first messages use the same CDM sequence and have different indicated SFOs.

At step 706, the network entity or reader device outputs, for transmission, at least one second message including resource allocation information for at least a third message. The resource allocation information in this second message is associated with the generated collision indicator. Step 706 represents the network entity's response to the detected collision scenario. The second message may take various forms depending on the specific implementation and network conditions.

In some instances, the second message includes the collision indicator itself, where the indicator is associated with one or more CDM sequences. This allows the receiving devices to understand which sequences were involved in the collision. The resource allocation information can be structured in different ways to address the collision. For example, the reader device may associate different portions of the resource allocation information with subsets of the first messages based on their SFO values. This approach allows for more targeted resource allocation and potentially reduces further collisions.

In certain implementations, the reader device may output multiple second messages that each include a portion of the resource allocation information. This strategy can be useful when the allocation information is too extensive to fit in a single message or when staggered transmission of allocation information is beneficial. When using multiple messages, the reader device may indicate the quantity of multiple resource allocations to help receiving devices account for the full scope of the allocation.

The resource allocation information may include multiple allocations, each associated with a different indicated SFO. Here, a granular approach to resource allocation takes into account the varying timing offsets of different devices to improve the efficiency of subsequent transmissions.

In the context of random access procedures, at least one of the one or more first messages may be a random access request, and the at least one second message serves as a random access response.

The method 700 described here provides a flexible approach to handling collisions in A-IoT communications, taking into account challenges posed by sampling frequency offsets in these low-complexity devices. By leveraging SFO information for collision detection and resource allocation, method 700 aims to improve the efficiency and reliability of network access for A-IoT devices.

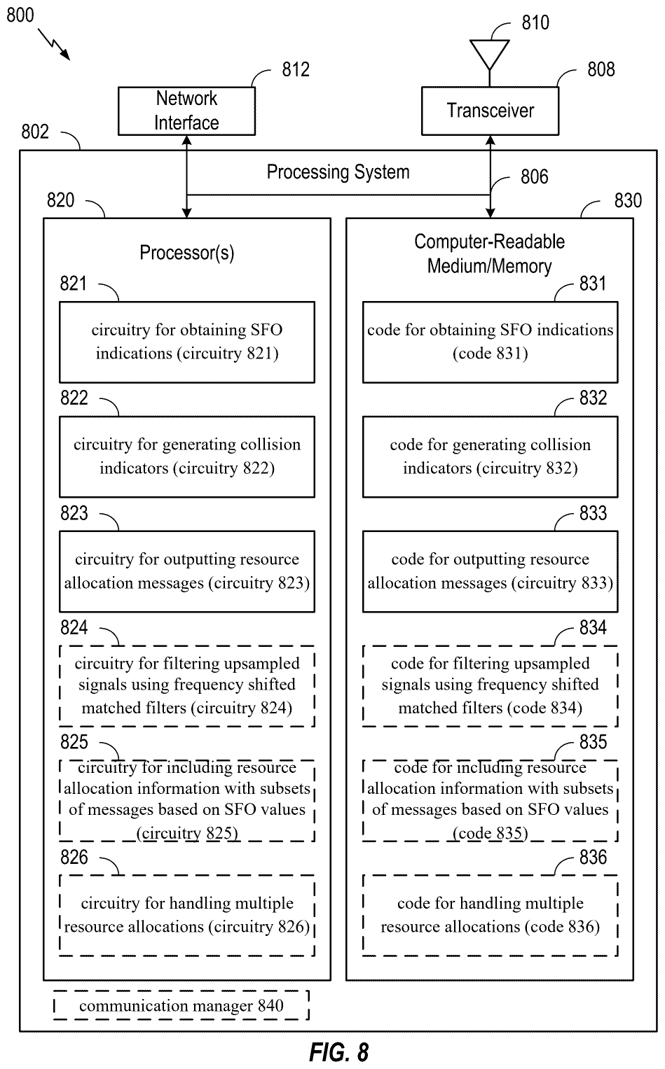

FIG. 8 depicts aspects of an example communications device 800. In some aspects, communications device 800 is a network entity, such as BS 102 of FIGS. 1 and 3, or a disaggregated base station as discussed with respect to FIG. 2, operating as or as part of a reader device. According to other aspects, communications device 800 may be a user equipment (UE), such as UE 104 described with reference to FIGS. 1 and 3. The specific role of communications device 800 may depend on the particular implementation and whether it is functioning as a reader or an A-IoT device in the context of the collision resolution techniques described herein.

The communications device 800 includes a processing system 802 coupled to a transceiver 808 (e.g., a transmitter and/or a receiver) and/or a network interface 812. The transceiver 808 is configured to transmit and receive signals for the communications device 800 via an antenna 810, such as the various signals as described herein. The network interface 812 is configured to obtain and send signals for the communications device 800 via communications link(s), such as a backhaul link, midhaul link, and/or fronthaul link as described herein, such as with respect to FIG. 2. The processing system 802 may be configured to perform processing functions for the communications device 800, including processing signals received and/or to be transmitted by the communications device 800.

The processing system 802 includes one or more processors 820. In various aspects, the one or more processors 820 may be representative of one or more of receive processor 338, transmit processor 320, TX MIMO processor 330, and/or controller/processor 340, as described with respect to FIG. 3. The one or more processors 820 are coupled to a computer-readable medium/memory 830 via a bus 806. In certain aspects, the computer-readable medium/memory 830 is configured to store instructions (e.g., computer-executable code) that when executed by the one or more processors 820, cause the one or more processors 820 to perform the method 700 described with respect to FIG. 7, or any aspect related to it. Note that reference to a processor of communications device 800 performing a function may include one or more processors of communications device 800 performing that function.

Device 800 includes circuitry for obtaining SFO indications (circuitry 821). Device 800 also includes code, stored in memory 830, for obtaining SFO indications (code 831). This functionality involves processing received signals to extract sampling frequency offset information associated with one or more first messages.

Device 800 includes circuitry for generating collision indicators (circuitry 822). Device 800 also includes code, stored in memory 830, for generating collision indicators (code 832). This process involves analyzing the obtained SFO indications to identify potential collisions between messages from different devices.

Device 800 includes circuitry for outputting resource allocation messages (circuitry 823). Device 800 also includes code, stored in memory 830, for outputting resource allocation messages (code 833). This function relates to preparing and transmitting at least one second message that includes resource allocation information for subsequent transmissions.

Device 800 includes circuitry for filtering upsampled signals using frequency shifted matched filters (circuitry 824). Device 800 also includes code, stored in memory 830, for filtering upsampled signals using frequency shifted matched filters (code 834). This functionality relates to a more detailed process of obtaining SFO indications, where each filter corresponds to a specific SFO value.

Device 800 includes circuitry for including resource allocation information with subsets of messages based on SFO values (circuitry 825). Device 800 also includes code, stored in memory 830, for including resource allocation information with subsets of messages based on SFO values (code 835). This function allows for more targeted resource allocation strategies based on the detected SFO values.

Device 800 includes circuitry for handling multiple resource allocations (circuitry 826). Device 800 also includes code, stored in memory 830, for handling multiple resource allocations (code 836). This functionality relates to scenarios where multiple second messages are used, each including a portion of the resource allocation information. It may also involve indicating the quantity of multiple resource allocations in the messages.

In certain implementations, device 800 may include additional circuitry and corresponding code stored in memory for processing random access requests and responses. This functionality relates to handling scenarios where the first messages are random access requests and the second messages are random access responses, which can be particularly relevant in A-IoT communication systems.

Device 800 may also incorporate circuitry and code for managing multiple resource allocations associated with different SFOs. This function allows device 800 to allocate different resources based on the specific SFO values detected, enabling more efficient use of communication resources in scenarios with varying timing offsets.

In some instances, device 800 may include capabilities for processing and generating CDM sequences. This functionality is related to detecting collisions when two or more first messages use the same CDM sequence or when they use the same sequence but have different SFOs, which is crucial for effective collision resolution in A-IoT systems.

Device 800 may also feature circuitry and code for managing collision indicators associated with CDM sequences. This function involves including collision indicators in the second messages and associating them with specific CDM sequences to provide meaningful collision information to A-IoT devices.

Depending on its specific role in the A-IoT system, device 800 may incorporate circuitry and code for implementing either network entity functions or UE functions. When configured as a network entity, this functionality allows the device to operate as a base station or reader device. Alternatively, when configured as a UE, it enables the device to function as an A-IoT device in the system. As described, the functionalities associated with device 800 can be implemented through various combinations of hardware and software components within device 800, which improves its versatility and ability to support complex collision resolution techniques in A-IoT communications.

Communications device 800 also includes a collision resolution manager 840, which supports collision detection and resolution for A-IoT devices in accordance with examples disclosed herein. Its features can include SFO-based collision detection, adaptive resource allocation strategies, and multi-message resource allocation handling.

Various components of the communications device 800 may provide means for performing the method 700 as described with respect to FIG. 7, or any aspect related to it. For example, means for transmitting, sending or outputting for transmission may include the transceivers 332 and/or antenna(s) 334 of the BS 102 illustrated in FIG. 3 and/or transceiver 808 and antenna 810 of the communications device 800 in FIG. 8. Means for receiving or obtaining may include the transceivers 332 and/or antenna(s) 334 of the BS 102 illustrated in FIG. 3 and/or transceiver 808 and antenna 810 of the communications device 800 in FIG. 8. Means for filtering may include the one or more processors 820 executing the code 834 for filtering upsampled signals using frequency shifted matched filters. Means for generating a collision indicator may include the one or more processors 820 executing the code 832 for generating collision indicators. Means for including resource allocation information may include the one or more processors 820 executing the code 835 for including resource allocation information with subsets of messages based on SFO values.

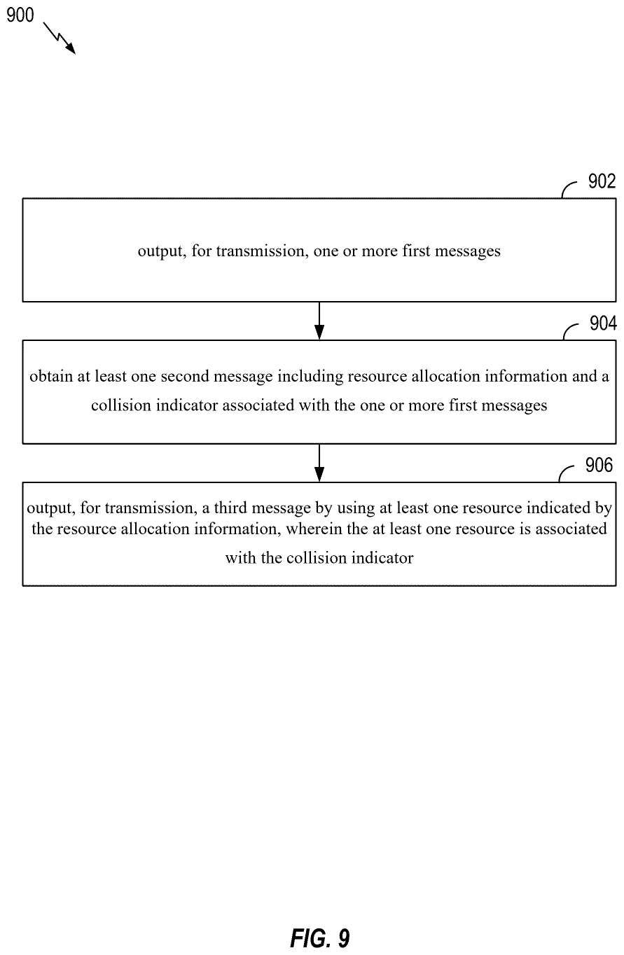

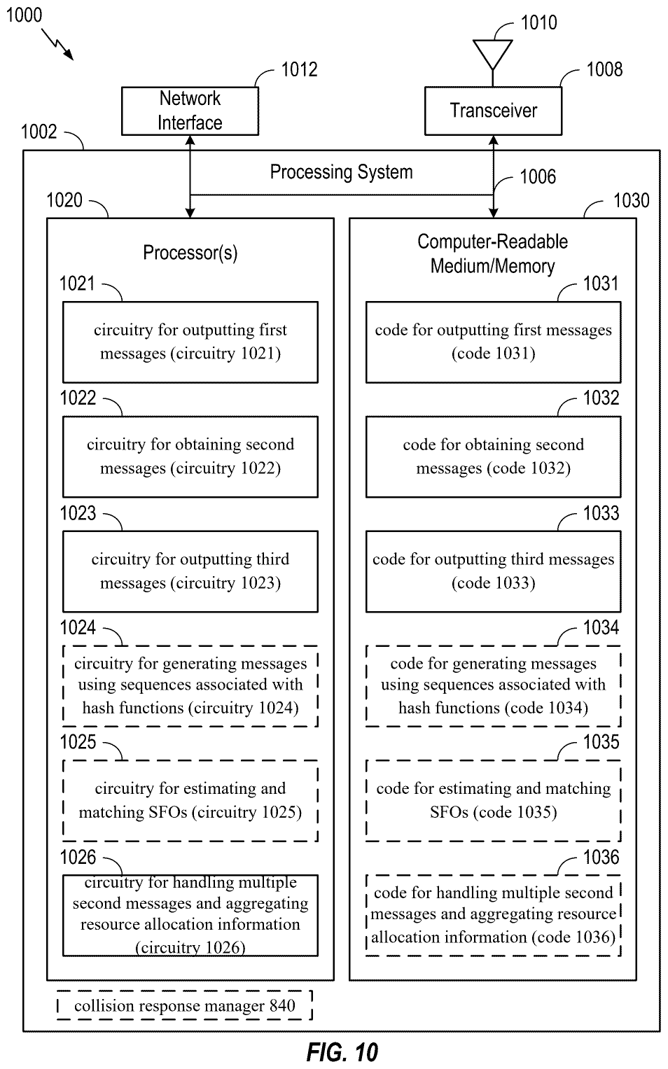

FIG. 9 shows a flowchart illustrating an example process 900 performable by or at an Internet of Things (IoT) device that supports collision resolution in Ambient IoT (A-IoT) communications according to aspects described herein. The operations of the process 900 may be implemented by a wireless IoT device or its components as described herein. For example, method 900 may be performed by a wireless communication device, such as the wireless communication device 1000 described with reference to FIG. 10, operating as an A-IoT device. In some examples, the process 900 may be performed by a UE 104 configured as an IoT device, as described with reference to FIG. 1. In other implementations, the process 900 may be performed by IoT devices as illustrated in FIGS. 5A and 5B. The IoT device performing method 900 may be a low-power, low-complexity device designed for efficient communication in an A-IoT network environment. This enables such devices to participate in collision resolution procedures and adapt their behavior based on feedback from network entities while maintaining their energy-efficient nature.

At step 902, the IoT device outputs, for transmission, one or more first messages. The first messages may be random access requests or other initial communications in the A-IoT system. In some implementations, the UE generates the first messages using a sequence associated with a hash function. This sequence may be a code division multiplexing (CDM) sequence, which in certain cases could be a pseudo-noise (PN) sequence. The use of such sequences allows for efficient communication while maintaining the low-complexity nature of A-IoT devices.

At step 904, the IoT device obtains at least one second message including resource allocation information and a collision indicator associated with the one or more first messages. The second message is typically a response from a network entity, such as reader device that has processed the first messages received from the IoT device (i.e., output at step 902) and detected potential collisions.

At step 906, the IoT device outputs, for transmission, a third message by using at least one resource indicated by the resource allocation information. Here, the allocated resource is associated with the collision indicator. Step 906 is the IoT device's response to the collision detection and resource allocation performed by the reader device.

In some implementations, the IoT device may perform additional operations based on the received collision indicator. For instance, if the collision indicator in the second message indicates a collision, the IoT device may generate a subsequent first message using a different sequence, where the different sequence is associated with a different hash function. Conversely, if the collision indicator indicates no collision or if no collision indicator is present, the IoT device may generate a subsequent first message using the same sequence associated with the original first message.

The IoT device may also employ techniques to handle the received information. In some implementations, it estimates a sampling frequency offset (SFO) based on a received signal associated with the second message. It then matches the estimated SFO with an SFO indicator in the second message and uses a resource allocation associated with the matched SFO indicator for transmitting the third message. This approach allows the UE to adapt its transmission to the specific timing offset detected by the network entity.

In certain implementations, the IoT device may receive multiple second messages that each contain partial resource allocation information. In such implementations, the IoT device aggregates the partial resource allocation information from these messages. It then uses a resource for the third message from the aggregated resource allocation information, potentially based on a random selection or a hash function. The foregoing implementations enable flexible resource allocation in complex network environments.

In some implementations, the IoT device may output the first messages for transmission via a backscattered signal. This can be advantageous because it allows for very low power consumption by the IoT devices.

The method 900 described here provides an approach for A-IoT devices to participate in collision resolution procedures and adapt their transmissions based on feedback from the network entity. By incorporating techniques such as sequence selection, SFO estimation, and aggregation of partial resource allocations, the method 900 enables efficient communication in challenging network conditions with an increased likelihood of potential collisions.

FIG. 10 depicts aspects of an example communications device 1000. In some aspects, communications device 1000 is an Internet of Things (IoT) device, such as those illustrated in FIGS. 5A and 5B. According to other aspects, communications device 1000 may be a user equipment (UE), such as UE 104 described with reference to FIGS. 1 and 3, configured to operate as an A-IoT device. The specific role of communications device 1000 may depend on the particular implementation, but it functions as an A-IoT device in the context of the collision resolution techniques described herein.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of one or more of receive processor 358, transmit processor 364, TX MIMO processor 366, and/or controller/processor 380, as described with respect to FIG. 3. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the method 900 described with respect to FIG. 9, or any aspect related to it. Note that reference to a processor of communications device 1000 performing a function may include one or more processors of communications device 1000 performing that function.

Device 1000 includes circuitry for outputting first messages (circuitry 1021). Device 1000 also includes code, stored in memory 1030, for outputting first messages (code 1031). This functionality involves generating and transmitting initial messages, which may be random access requests or other communications in the A-IoT system.

Device 1000 includes circuitry for obtaining second messages (circuitry 1022). Device 1000 also includes code, stored in memory 1030, for obtaining second messages (code 1032). This involves receiving and processing messages that include resource allocation information and collision indicators from a network entity.

Device 1000 includes circuitry for outputting third messages (circuitry 1023). Device 1000 also includes code, stored in memory 1030, for outputting third messages (code 1033). This function relates to transmitting subsequent messages using resources indicated by the resource allocation information received in the second messages.

Device 1000 includes circuitry for generating messages using sequences associated with hash functions (circuitry 1024). Device 1000 also includes code, stored in memory 1030, for generating messages using sequences associated with hash functions (code 1034). This functionality relates to creating messages using specific sequences, which may be CDM or PN sequences.

Device 1000 includes circuitry for estimating and matching SFOs (circuitry 1025). Device 1000 also includes code, stored in memory 1030, for estimating and matching SFOs (code 1035). This function allows the device to estimate its own SFO and match it with SFO indicators received from the network entity for appropriate resource selection.

Device 1000 includes circuitry for handling multiple second messages and aggregating resource allocation information (circuitry 1026). Device 1000 also includes code, stored in memory 1030, for handling multiple second messages and aggregating resource allocation information (code 1036). This functionality relates to scenarios where resource allocation information is split across multiple messages.

In certain implementations, device 1000 may include additional circuitry and corresponding code stored in memory for generating subsequent messages based on collision indicators. This functionality relates to adapting message generation when collisions are detected or not detected.

Device 1000 may also incorporate circuitry and code for backscatter signal transmission. This function allows the device to transmit messages using backscatter modulation in accordance with low-power A-IoT devices.

Device 1000 may also feature circuitry and code for random selection or hash-based resource selection from aggregated allocation information. This function involves selecting transmission resources from multiple options provided by the network entity.

The foregoing additional functionalities can be implemented through various combinations of hardware and software components within device 1000, enhancing its ability to participate in complex collision resolution techniques in A-IoT communications while maintaining low power consumption.

Communications device 1000 also includes a collision response manager 1040, which supports the IoT device's participation in collision resolution for A-IoT communications in accordance with examples disclosed herein. Its features include sequence generation, SFO estimation and matching, and handling of multi-message resource allocations.

Various components of the communications device 1000 may provide means for performing the method 900 as described with respect to FIG. 9, or any aspect related to it. For example, means for transmitting, sending or outputting for transmission may include the transceivers 354 and/or antenna(s) 352 of the UE 104 illustrated in FIG. 3 and/or transceiver 1008 and antenna 1010 of the communications device 1000 in FIG. 10. Means for receiving or obtaining may include the transceivers 354 and/or antenna(s) 352 of the UE 104 illustrated in FIG. 3 and/or transceiver 1008 and antenna 1010 of the communications device 1000 in FIG. 10. Means for generating messages using sequences associated with hash functions may include the one or more processors 1020 executing the code 1034 for generating messages using sequences associated with hash functions. Means for estimating and matching SFOs may include the one or more processors 1020 executing the code 1035 for estimating and matching SFOs. Means for handling multiple second messages and aggregating resource allocation information may include the one or more processors 1020 executing the code 1036 for handling multiple second messages and aggregating resource allocation information. Means for backscatter signal transmission may include the transceiver 1008 configured for backscatter modulation.

Implementation examples are described in the following numbered clauses:
Clause 1: A method for wireless communication at a network node, comprising: obtaining an indication of one or more sampling frequency offsets (SFOs) associated with one or more first messages; generating a collision indicator associated with the one or more first messages based on the obtained SFO indication; and outputting, for transmission, at least one second message including resource allocation information for at least a third message, wherein the resource allocation information is associated with the generated collision indicator.
Clause 2: The method of Clause 1, wherein the collision indicator is generated if two or more of the first messages use a same code division multiplexing (CDM) sequence.
Clause 3: The method of any one of Clauses 1-2, wherein the collision indicator is generated if two or more of the first messages have different ones of the indicated SFOs.
Clause 4: The method of any one of Clauses 1-3, wherein the collision indicator is generated when two or more of the first messages use a same code division multiplexing (CDM) sequence and have different ones of the indicated SFOs.
Clause 5: The method of any one of Clauses 1-4, further comprising at least one of: including, in the at least one second message, a first portion of the resource allocation information for a first subset of the one or more first messages, the first subset corresponding to a first SFO value; or including, in the at least one second message, a second portion of the resource allocation information for a second subset of the one or more first messages, the second subset corresponding to a second SFO value different from the first SFO value.
Clause 6: The method of any one of Clauses 1-5, wherein the at least one second message further includes the collision indicator, where the collision indicator is associated with one or more code division multiplexing (CDM) sequences.
Clause 7: The method of any one of Clauses 1-6, wherein the at least one second message comprises a plurality of second messages, wherein each of the plurality of second messages include a portion of the resource allocation information.
Clause 8: The method of Clause 7, wherein the at least one second message indicates a quantity of the multiple resource allocations.
Clause 9: The method of any one of Clauses 1-8, wherein at least one of the one or more first messages is a random access request and the at least one second message is a random access response.
Clause 10: The method of any one of Clauses 1-9, wherein the resource allocation information includes multiple resource allocations, each associated with a different one of the indicated SFOs.
Clause 11: The method of any one of Clauses 1-10, wherein obtaining the indication comprises: obtaining an upsampled signal; and filtering the upsampled signal by using one or more frequency shifted matched filters, each of the filters corresponding to a SFO value.
Clause 12: The method of any one of Clauses 11, further comprising: receiving the indication; and transmitting the at least one second message.
Clause 13: A method for wireless communication at a network node, comprising: outputting, for transmission, one or more first messages; obtaining at least one second message including resource allocation information and a collision indicator associated with the one or more first messages; and outputting, for transmission, a third message by using at least one resource indicated by the resource allocation information, wherein the at least one resource is associated with the collision indicator.
Clause 14: The method of Clause 13, further comprising: generating the one or more first messages by using a sequence, wherein the sequence is associated with a hash function; and outputting, for transmission, the one or more first messages using the sequence.
Clause 15: The method of any one of Clauses 13-14, wherein the sequence comprises a code division multiplexing (CDM) sequence.
Clause 16: The method of any one of Clauses 13-15, wherein the CDM sequence comprises a pseudo-noise (PN) sequence.
Clause 17: The method of any one of Clauses 13-16, further comprising at least one of: generating a subsequent first message using a different sequence if the collision indicator in the at least one second message indicates a collision, wherein the different sequence is associated with a different hash function; or generating a subsequent first message using the sequence associated with the first message if the collision indicator in the at least one second message indicates no collision or if the collision indicator is not present in the at least one second message.
Clause 18: The method of any one of Clauses 13-17, wherein the one or more processors are further configured to cause the apparatus to: estimate a sampling frequency offset (SFO), said estimate being based on the at least one second message; obtain an indication of a resource allocation from the resource allocation information in the at least one second message, wherein the indicated resource allocation is associated with the estimated SFO; and the third message is outputted for transmission using the indicated resource allocation.
Clause 19: The method of any one of Clauses 13-18, wherein the at least one second message comprises a plurality of second messages, each of the plurality of second messages including a portion of the resource allocation information.
Clause 20: The method of any one of Clauses 13-19, wherein the one or more first messages are output, for transmission, via a backscattered signal.
Clause 21: The method of Clause 19, further comprising: aggregating the portions of the resource allocation information from the plurality of second messages; and wherein the third message is outputted for transmission using a resource allocation from the aggregated portions associated with at least one of a random selection or a hash function.
Clause 22: The method of any one of Clauses 13-21, further comprising: transmitting the one or more first messages; receiving the second message; and transmitting the third message.
Clause 23: An apparatus for wireless communication, comprising: a memory comprising executable instructions; and one or more processors configured to execute the executable instructions and cause the apparatus to perform a method in accordance with any one of Clauses 1-22.
Clause 24: An apparatus for wireless communication, comprising means for performing a method in accordance with any one of Clauses 1-22.
Clause 25: A non-transitory computer-readable medium comprising executable instructions that, when executed by one or more processors of an apparatus, cause the apparatus to perform a method in accordance with any one of Clauses 1-22.
Clause 26: A computer program product embodied on a computer-readable storage medium comprising code for performing a method in accordance with any one of Clauses 1-22.
Clause 27: A wireless node (e.g., a network entity), comprising: one or more transceivers; one or more processors; and one or more memories comprising instructions executable by the one or more processors to cause the wireless node perform a method in accordance with any one of Clauses 1-12, wherein the at least one transceiver is configured to receive the indication and transmit the at least one second message.
Clause 28: A wireless node (e.g., a user equipment) for wireless communication, comprising: one or more transceivers; one or more processors; and one or more memories comprising instructions executable by the one or more processors to cause the wireless node to perform a method in accordance with any one of Clauses 13-22, wherein the at least one transceiver is configured to transmit the one or more first messages, receive the second message and transmit the third message.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication, comprising:
one or more memories that store processor-executable code; and
one or more processors, individually or collectively, configured to execute the code and cause the apparatus to:
obtain an indication of one or more sampling frequency offsets (SFOs) associated with one or more first messages;
generate a collision indicator associated with the one or more first messages based on the obtained SFO indication; and
output, for transmission, at least one second message including resource allocation information for at least a third message, wherein the resource allocation information is associated with the collision indicator.

2. The apparatus of claim 1, wherein the collision indicator is generated if two or more of the first messages use a same code division multiplexing (CDM) sequence.

3. The apparatus of claim 1, wherein the collision indicator is generated if two or more of the first messages have different ones of the indicated SFOs.

4. The apparatus of claim 1, wherein the collision indicator is generated when two or more of the first messages use a same code division multiplexing (CDM) sequence and have different ones of the indicated SFOs.

5. The apparatus of claim 1, wherein the one or more processors are further configured to cause the apparatus to at least one of:
include, in the at least one second message, a first portion of the resource allocation information for a first subset of the one or more first messages, the first subset corresponding to a first SFO value; or
include, in the at least one second message, a second portion of the resource allocation information for a second subset of the one or more first messages, the second subset corresponding to a second SFO value different from the first SFO value.

6. The apparatus of claim 1, wherein the at least one second message further includes the collision indicator, where the collision indicator is associated with one or more code division multiplexing (CDM) sequences.

7. The apparatus of claim 1, wherein the at least one second message comprises a plurality of second messages, wherein each of the plurality of second messages include a portion of the resource allocation information.

8. The apparatus of claim 7, wherein the at least one second message indicates a quantity of the multiple resource allocations.

9. The apparatus of claim 1, wherein at least one of the one or more first messages is a random access request and the at least one second message is a random access response.

10. The apparatus of claim 1, wherein the resource allocation information includes multiple resource allocations, each associated with a different one of the indicated SFOs.

11. The apparatus of claim 1, wherein obtaining the indication comprises:
obtaining an upsampled signal; and
filtering the upsampled signal by using one or more frequency shifted matched filters, each of the filters corresponding to a SFO value.

12. The apparatus of claim 1, wherein the apparatus further comprises at least one transceiver configured to:
receive the indication; and
transmit the at least one second message,
wherein the apparatus is configured as a network entity.

13. A apparatus for wireless communication, comprising:
one or more memories that store processor-executable code; and
one or more processors, individually or collectively, configured to execute the code and cause the apparatus to:
output, for transmission, one or more first messages;
obtain at least one second message including resource allocation information and a collision indicator associated with the one or more first messages; and
output, for transmission, a third message by using at least one resource indicated by the resource allocation information, wherein the at least one resource is associated with the collision indicator.

14. The apparatus of claim 13, wherein:
the one or more processors are further configured to cause the apparatus to generate the one or more first messages by using a sequence, wherein the sequence is associated with a hash function; and
the one or more first messages are output for transmission by using the sequence.

15. The apparatus of claim 14, wherein the sequence comprises a code division multiplexing (CDM) sequence.

16. The apparatus of claim 15, wherein the CDM sequence comprises a pseudo-noise (PN) sequence.

17. The apparatus of claim 14, wherein the one or more processors are further configured to cause the apparatus to at least one of:
generate a subsequent first message using a different sequence if the collision indicator in the at least one second message indicates a collision, wherein the different sequence is associated with a different hash function; or
generate a subsequent first message using the sequence associated with the first message if the collision indicator in the at least one second message indicates no collision or if the collision indicator is not present in the at least one second message.

18. The apparatus of claim 13, wherein:
the one or more processors are further configured to cause the apparatus to:
estimate a sampling frequency offset (SFO), said estimate being based on the at least one second message;
obtain an indication of a resource allocation from the resource allocation information in the at least one second message, wherein the indicated resource allocation is associated with the estimated SFO; and
the third message is outputted for transmission using the indicated resource allocation.

19. The apparatus of claim 13, wherein the at least one second message comprises a plurality of second messages, each of the plurality of second messages including a portion of the resource allocation information.

20. The apparatus of claim 13 wherein the one or more first messages are output, for transmission, via a backscattered signal.

21. The apparatus of claim 19, wherein:
the one or more processors are further configured to cause the apparatus to aggregate the portions of the resource allocation information from the plurality of second messages; and
the third message is outputted for transmission using a resource allocation from the aggregated portions associated with at least one of a random selection or a hash function.

22. The apparatus of claim 13, wherein the apparatus further comprises at least one transceiver configured to:
transmit the one or more first messages;
receive the second message; and
transmit the third message,
wherein the apparatus is configured as a network entity.
